(19) United States
(12) Patent Application Publication
(10) Pub. No.: US 2010/0154066 A1
(43) Pub. Date: Jun. 17, 2010

(54) System and Method for Managing Security Testing

(75) Inventors: Peter C. Hammes, Washington, DC (US); David W. Brock, Gaithersburg, MD (US); Robert A. McNeal, Nokesville, VA (US); Jeremiah J.D. Sahlberg, Haymarket, VA (US)

Correspondence Address: DUANE MORRIS LLP - DC, 505 9th Street, Suite 1000, WASHINGTON, DC, 20004-2166, US

(73) Assignee: Tekmark Global Solutions, LLC, Edison, NJ (US)

(21) Appl. No.: 12/712,663

(22) Filed: Feb. 25, 2010

Related U.S. Application Data
(62) Division of application No. 11/394,223, filed on Mar. 31, 2006.
(60) Provisional application No. 60/715,136, filed on Sep. 9, 2005.

(51) Int. Cl. G06F 17/30

(52) U.S. Cl. 726/30

(57) ABSTRACT

The subject matter relates generally to a system and method for managing security testing. Particularly, this invention relates to maintaining a security database by correlating multiple sources of vulnerability data and also to managing security testing from plural vendors. This invention also relates to providing secure session tracking by performing plural authentications of a user.

### CROSS-REFERENCE TO RELATED APPLICATIONS

This application is a divisional application of co-pending application Ser. No. 11/394,223 filed Mar. 31, 2006, the entirety of which is incorporated herein by reference, which claims priority from U.S. Provisional Application Ser. No. 60/715,136 filed on Sep. 9, 2005.

### BACKGROUND

Computers, computer systems, and computer applications are becoming increasingly complex. Additionally, with the creation of the Internet and other modern networking technology, computers have become increasingly interconnected and remote accessibility of individual computers and computer networks has become more and more common. Due to this complexity, the number of computer security vulnerabilities that need to be addressed continues to increase exponentially. Given these trends, it has become increasingly difficult to protect computers from security breaches via these vulnerabilities. Moreover, the task of maintaining security for these computer systems and/or networks has become increasingly burdensome and difficult.

Additionally, the complexity of the regulatory environment governing computer security is rapidly exploding. For example, the enactment of the Gramm-Leach-Bliley Act of 1999 tore down barriers between the banking, securities and insurance businesses while redefining the roles of federal/state governments and agencies in regulating financial services. As a result, such businesses are now faced with ensuring the security and confidentiality of their customer information, protecting against threats to the security of this information, protecting against unauthorized access to this information, and providing internal and external reports that verify security testing. Organizations may face serious potential liability if they fail to comply with these regulations.

Currently, organizations have a wide variety of resources available for determining security vulnerabilities. Organizations may use vulnerability scanning software, such as Nessus Vulnerability Scanner, or managed security solutions, such as Tek+Detect^{SM}, to test computers for security weaknesses. These resources generally provide detailed information on the vulnerabilities found in the computing environment, but each may describe the same vulnerability in a different way. This could result in the same vulnerability being reported multiple times. Additionally, numerous public sources of vulnerability data are available such as Open Source Vulnerability Database (“OSVDB”) and Common Vulnerabilities & Exposures (“CVE”). While these public sources may be extremely valuable, they each offer information on specific vulnerabilities in their own proprietary formats. Due to the multiplicity of vulnerability reporting formats, the increasing volume of vulnerabilities and the complexity of tracking multiple vendors of security services, organizations are expending ever increasing portions of their resources managing their security portfolios. A serious need exists in the industry for a means of delivering normalized security vulnerability information and for a cost-effective means of managing these numerous security resources securely.

Moreover, in a typical networked organization, one or more users may be connected to a security database application via a communication network. This networking greatly increases the risk of a security breach, especially when the users are communicating via a public network such as the Internet. When sensitive security data is made available to multiple parties, it is therefore necessary to take steps to ensure that only authorized personal have access. Additionally, because a single user may access multiple sets of information in one session, it is important to provide a secure means of session tracking that allows for multiple authentications of a user.

A number of measures, e.g. encryption procedures, have been used to reduce the vulnerability of the networked systems to unauthorized access. Conventional encryption procedures encode data to prevent the unauthorized access, especially during the transmission of the data. Encryption techniques are generally based on one or more keys, or codes, which are essential for decoding, or reverting the data into a readable form. These techniques provide a protection against the first kind of attacks which include intercepting and manipulating the data as it is being transmitted. The encryption techniques not only allow the authentication of the sender of a message, but also serve to verify the integrity of the message itself, thus proving that the message has not been altered during the transmission. Such techniques include the use of keys, salts, digital signatures and hash algorithms.

### SUMMARY OF THE INVENTION

In accordance with the present disclosure, a system and method are presented that provide a technique for managing security testing. Particularly, this invention relates to maintaining a security database by correlating multiple sources of vulnerability data and managing security testing from plural vendors. Additionally, the security database provides means for secure session tracking involving multiple user authentications.

In one embodiment, a system and method of maintaining a computer security database by providing a database containing computer security vulnerability data keyed to unique database identifiers; obtaining computer security vulnerability data from multiple computer security data sources; providing a cross-reference database correlating the data from multiple sources; determining if a particular vulnerability is described by more than one source; and if so, entering that particular vulnerability into the security database associated with all the sources that describe the vulnerability.

In another embodiment, a system and method for managing computer security testing using data from plural sources by providing a computer security information database adapted to receive data from plural computer security data sources; retrieving information on security tasks performed and reports of security task results from multiple sources; displaying the information and reports on a display device; and managing security vulnerability as a function of the information and reports.

In yet another embodiment, a system and method for authenticating a user plural times during an access session by receiving a username and password, or other identifying information, from a user; authenticating the user; allowing access to a first set of information; and re-authenticating the user upon receipt of a request from the user to access a second set of information.

One advantage of the present invention is the provision of a normalized security vulnerability database that receives security vulnerability data from multiple data sources.

Another advantage of the present invention is the provision of a normalized security vulnerability database that is continuously updated with security vulnerability data from multiple data sources.

Another advantage of the present invention is the provision of a system for managing security testing information from multiple sources while providing for internal controls.

Yet another advantage of the present invention is the provision of a method for maintaining secure session access to multiple sets of information by authenticating a user multiple times.

Still other benefits and advantages of the invention will become apparent to those skilled in the art upon a reading and understanding of the following detailed specification.

### BRIEF DESCRIPTION OF THE DRAWINGS

FIG. 1 is a block diagram illustrating an exemplary embodiment of a system and method for implementing a security vulnerability database in accordance with the present disclosure.

FIG. 2 is a block diagram illustrating another aspect of a security vulnerability database in accordance with the present disclosure.

FIG. 3 is a block diagram illustrating an embodiment of a database for managing security data from a plurality of vendors in accordance with the present disclosure.

FIG. 4 is a block diagram illustrating an embodiment of a secure session tracking method in accordance with the present disclosure.

FIG. 5 is a block diagram illustrating a further embodiment of a secure session tracking method in accordance with the present disclosure.

### DETAILED DESCRIPTION OF EMBODIMENTS

In this disclosure, numerous specific details are set forth to provide a sufficient understanding of the present invention. However, those skilled in the art will appreciate that the present invention may be practiced without such specific details. In other instances, well-known elements have been illustrated in schematic or block diagram form in order not to obscure the present invention in unnecessary detail. Additionally, some details have been omitted inasmuch as such details are not considered necessary to obtain a complete understanding of the present invention, and are considered to be within the understanding of persons of ordinary skill in the relevant art. It is further noted that all functions described herein may be performed in either hardware or software, or a combination thereof, unless indicated otherwise. Certain terms are used throughout the following description and claims to refer to particular system components. As one skilled in the art will appreciate, components may be referred to by different names. This document does not intend to distinguish between components that differ in name, but not function.

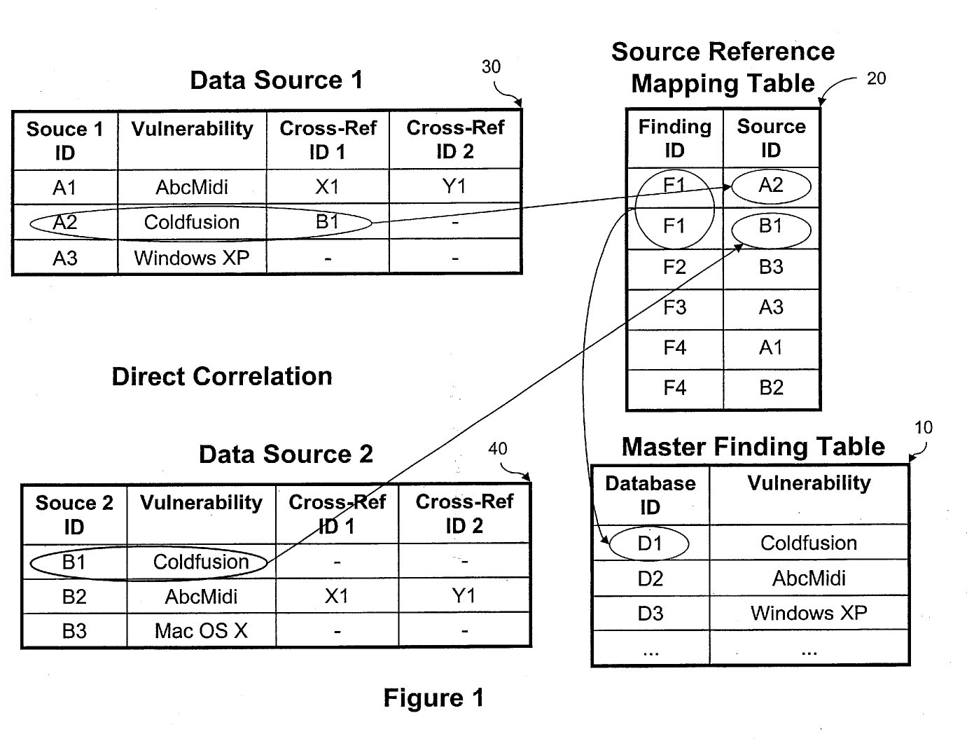

FIG. 1 is a block diagram illustrating an exemplary embodiment of a system and method for implementing a security vulnerability database in accordance with the present invention. As shown in FIG. 1, the system comprises a security vulnerability database composed of: a master finding table 10 containing sets of data each with a unique database identifier; and a source reference mapping table 20 containing finding identifiers correlated with data source identifiers. The security vulnerability database may be any public or commercial database such as TekSecureLabs (TSL) Knowledgebase. The security vulnerability database obtains security vulnerability data from a plurality of security vulnerability data sources 30 and 40 and parses the data into the security vulnerability database. These data sources may be public or commercial vulnerability databases such as OSVDB and CVE, or vulnerability scanning software such as Nessus, AppScan, Burp Proxy, Nmap, Nikto, WebInspect, WebScanner or Tek+Detect^{SM}. The security vulnerability database may access the data sources via any communications network, such as an internal LAN or the Internet.

Each set of security vulnerability data in a data source describes a particular security vulnerability and has a unique source identifier assigned to it. For example, in data source 30 of FIG. 1, source identifier Al relates to a security vulnerability in abcMIDI open source software, source identifier A2 relates to a security vulnerability in Macromedia Coldfusion software, and source identifier A3 relates to a security vulnerability in Microsoft Windows XP. Additionally, in data source 40 of FIG. 1, source identifier B1 relates to a security vulnerability in Macromedia Coldfusion software, source identifier B2 relates to a security vulnerability in abcMIDI open source software, and source identifier B3 relates to a security vulnerability in Apple Mac OS X. A set of security data may contain one or more cross-reference identifiers that correspond to the unique source identifiers of other data sources. For example, in data source 30, the vulnerability associated with A2 has a cross-reference identifier to the source identifier B1 of data source 40. This indicates that A2 and B1 both relate to the same Macromedia Coldfusion security vulnerability. A set of security vulnerability data may also contain one or more of the following fields: a name of a security vulnerability, a description of the security vulnerability, a recommendation for correcting the vulnerability, an assigned priority level for the security vulnerability and a categorization of the technology platform affected by the security vulnerability. The technology platform affected may be a computer, network, operating system or software application. The data in the data sources may be obtained by performance of any security diagnostic operation such as a vulnerability scan, an ethical hack or a web application security test.

The source identifiers may be parsed into a source reference mapping table 20 that may contain a number of entries. Each entry in the source reference mapping table 20 contains a finding identifier and a source identifier. Each source identifier for a particular data set is correlated to a finding identifier based upon the cross-reference identifiers. If the cross-reference identifiers of a particular data set identify the source identifiers of another data set, both data sets will be assigned the same finding identifier by either direct or indirect correlation.

Direct correlation of source identifiers is illustrated in FIG. 1. Data source 30 contains a data set with a source identifier A2 and a cross-reference identifier B1. This cross-reference identifier corresponds to the source identifier B1 of data source 40. This indicates that both source identifiers A2 and B1 relate to the same Macromedia Coldfusion security vulnerability. Accordingly, both A2 and B1 are assigned the same finding identifier F1.

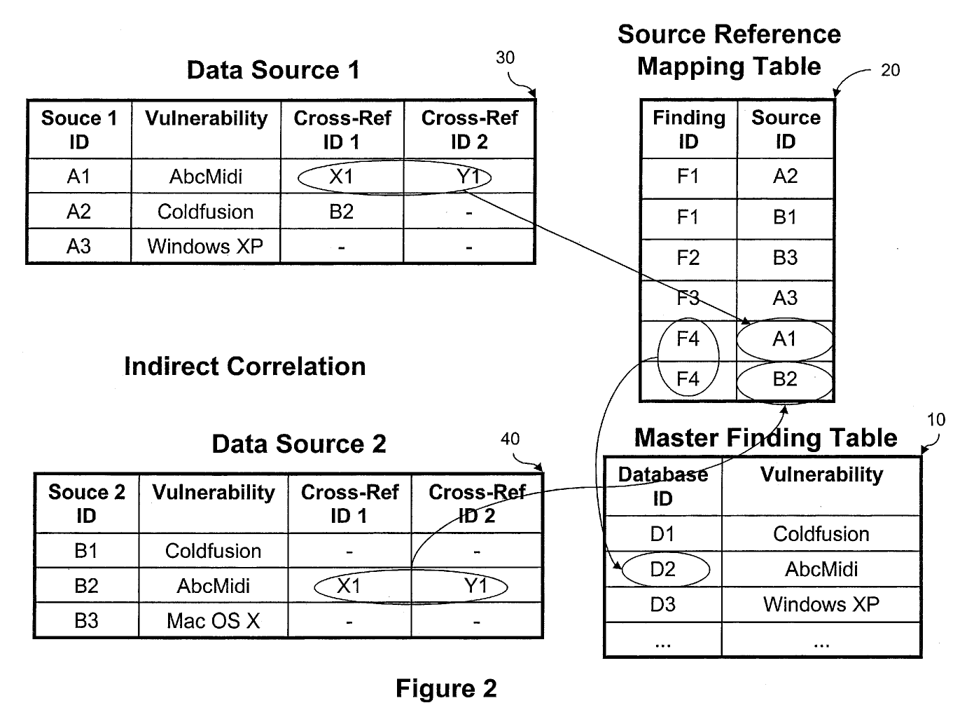

Indirect correlation of source identifiers is illustrated in FIG. 2. Data source 30 contains a data set with a source identifier A1 relating to an abcMIDI security vulnerability and cross-reference identifiers X1 and Y1. Note that data set A1 does not contain any cross-reference identifiers that correspond to any source identifiers in data source 40. Data source 40 contains a data set with a source identifier B2 relating to an abcMIDI security vulnerability and cross-reference identifiers X1 and Y1. This indicates that both A1 and B2 relate to the same abcMIDI security vulnerability because the cross reference identifiers of data sets A1 and B2 are the same. Therefore source identifiers A1 and B2 are both parsed into source reference mapping table 20 and both are assigned finding identifier F4. Although two matching cross-reference identifiers are illustrated, only one cross-reference identifier needs to be the same in both data sets to perform a correlation.

Once the source identifiers and finding identifiers are entered into the source reference matching table 20, the data sets corresponding to these source identifiers are entered into the master finding table 10. All data sets corresponding to entries in the source reference matching table 20 having the same finding identifier will be entered into the master finding table 10 as a single normalized data set. The single data set will then be assigned a unique database identifier. This is illustrated in FIG. 1 where source identifiers A2 and B1 are both assigned finding identifier F1 because they both relate to the same Macromedia Coldfusion security vulnerability. The data sets corresponding to source identifiers A2 and B1 are both entered into the master finding table 10 as a single data set and assigned database identifier D1. The single normalized data set may be comprised of the data set from any one data source or may be a compilation of data sets. For example, the Macromedia Coldfusion vulnerability data related to database identifier D1 may come from one or both data sources. Once a data set is assigned a unique database identifier, the database identifier may then be entered into the source reference mapping table 20 associated with the corresponding finding identifier.

In an alternative embodiment, a data set describing a particular security vulnerability may be entered directly into the master finding table 10. For example, an internal security department may perform a security diagnostic on an organizational network and enter the results directly into the master finding table 10. This new entry would then be assigned a unique database identifier and entered into the source reference mapping table 20.

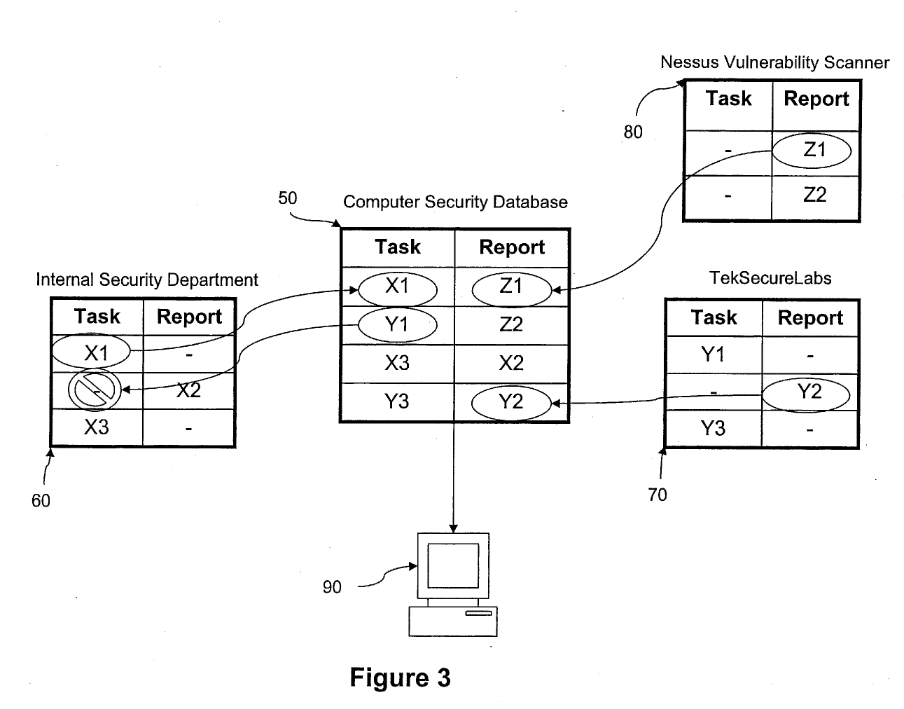

FIG. 3 is a block diagram illustrating an embodiment of a database for managing security data from a plurality of vendors in accordance with the present invention. As shown in FIG. 3, the system comprises a computer security database 50 adapted to receive security data from plural computer security data sources 60, 70 and 80. Although three data sources are shown in FIG. 3, any number of data sources may be used. The computer security database may access the data sources via any communications network, such as an internal LAN or the Internet.

The computer security database 50 may be a public or commercial database operated by an organization. The data sources may be public or commercial vulnerability data sources such as OSVDB, TekSecureLabs (TSL) Knowledgebase and CVE, or vulnerability scanning software such as Nessus, AppScan, Burp Proxy, Nmap, Nikto, WebInspect or WebScanner. The data sources may alternatively be an internal computer security department or an external contractor of computer security services such as Tekmark Global Solutions LLC.

The data sources contain information on security tests and reports of security test results. Specifically, the data sources may have information fields that contain: a name of a security vulnerability, a description of a security vulnerability, a recommendation for correcting the security vulnerability, an assigned priority level for the security vulnerability, and a categorization of the technology platform affected by the security vulnerability. The information and reports may be generated as a result of performing security testing on various technology platforms including computers, networks, operating systems and software applications. This security testing may be a vulnerability scan, an ethical hack, a web application security test, or system security configuration assessment.

Internal computer security departments and external contractors may be given access to retrieve data from the computer security database 50. However, this access may be restricted to implement internal controls and maintain data confidentiality. Restrictions may be implemented either by preventing access to data produced by any other data source, or by selectively preventing access to data from particular data sources. By way of example, as illustrated in FIG. 3, data source 60 is an internal computer security department that produced information on security tasks X1, X3 and report X2. Data source 70 is external contractor Tekmark Global Solutions LLC and has produced information Y1, Y3 and report Y2. Data source 80 is Nessus Vulnerability Scanner that has produced report Z1. While data source 60 can freely access X1 and Z1, it is prevented from accessing Y1, Y2 or Y3.

The computer security database 50 may compile the security information from the data sources to generate various useful reports. For example, the computer security database could generate a statistical analysis, a trend analysis, a comparative risk rating, a risk comparison chart, a security vulnerability frequency chart, a list of most common security vulnerabilities, or a list of weighted security vulnerabilities impact chart. Once the computer security database 50 obtains security data, information and reports may be produced on demand and displayed on any suitable display device 90 such as a computer monitor or computer printout. The information and reports may then be used for managing an organization's security vulnerabilities across various technology platforms, or verifying compliance with regulatory, legal, or business standard's requirements.

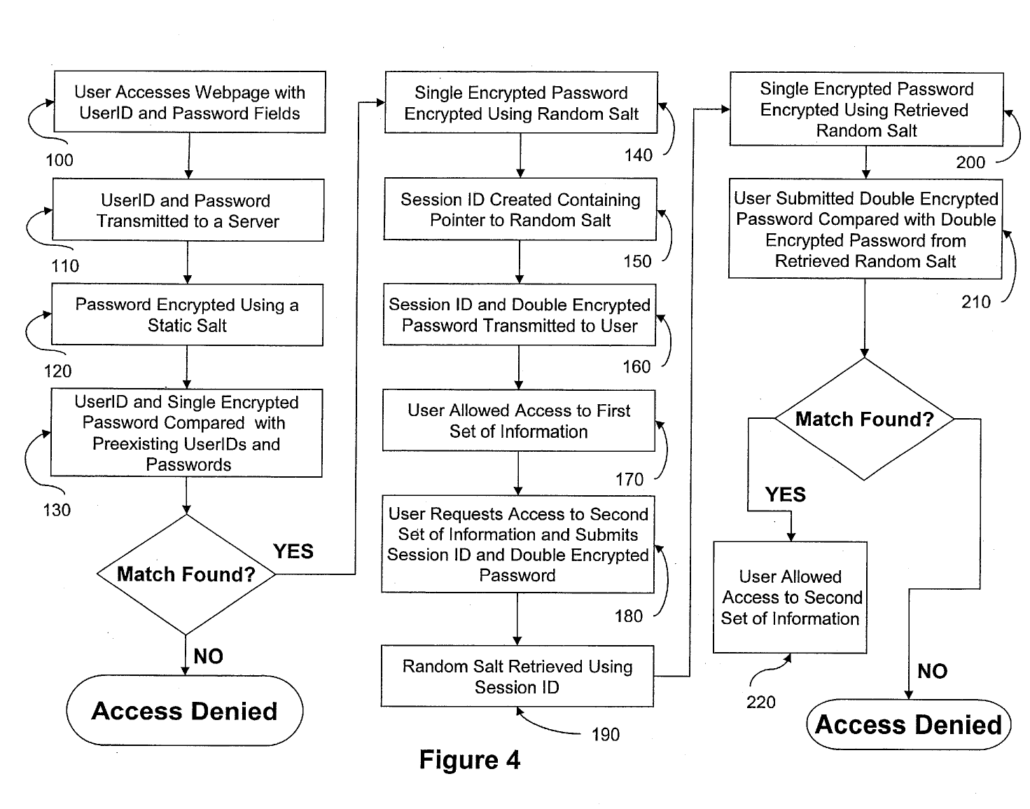

FIG. 4 is a block diagram illustrating an embodiment of a secure session tracking method in accordance with the present invention. As shown in FIG. 4, the method comprises receiving a username and password from a client; authenticating the user; allowing the user access to a first set of information; and re-authenticating the user upon receipt of a request to access a second set of information.

As illustrated in FIG. 4, the session tracking method begins with a user accessing a webpage that contains at least UserID and password fields in step 100. The initial webpage allows the user to request access to a first set of information such as an online database, secure webpage, secure network or web application. Once the user inputs his UserID and password, they are transmitted to a server running the session tracking application via a network in step 110. Alternatively, a user could transmit identification information such as an encrypted identification string or biometric data. The data may be transmitted via any transmission protocol such as HTTP, S-HTTP or HTTPS.

The server next encrypts the received password using a salt in step 120. A salt is a string of characters used to increase the number of encrypted strings that can be generated for a given string with a given encryption method. Salts help increase the effort needed to “crack” encrypted data. In step 120 the salt is static, however a random salt may also be used. If identification information is used, some portion of the information may be encrypted instead to create the encrypted password. The session tracking application next compares the UserID and single encrypted password with a pre-existing database of authorized UserIDs and passwords in step 130. If a match is not found, the user is denied access. If a match is found, the single encrypted password is then stored in memory and encrypted again to create a double encrypted password, this time using a random salt in step 140. The server also creates a session ID containing a pointer to the random salt that is stored in memory in step 150. Next, the server transmits the session ID and the double encrypted password back to the user in step 160 and allows the user access to the requested data in step 170. Allowing the user access may involve, for example, displaying database information or running a web application for the user.

The user then requests access to a second set of information, such as a second database, secure webpage, web application or secure network in step 180. To request access, the user may submit the session ID and the double encrypted password to the server. The server then uses the received session ID to retrieve the random salt stored in memory in step 190. Alternatively, the session ID may be used to re-generate the random salt. The server also retrieves the user's single encrypted password that was previously stored. In step 200, the previously stored single encrypted password is encrypted using the retrieved random salt to generate a second double encrypted password. The server then compares this second double encrypted password with the double encrypted password submitted by the user in step 210. If the generated password matches the submitted password, then the user is allowed access to the second set of information in step 220. Otherwise, the user is denied access.

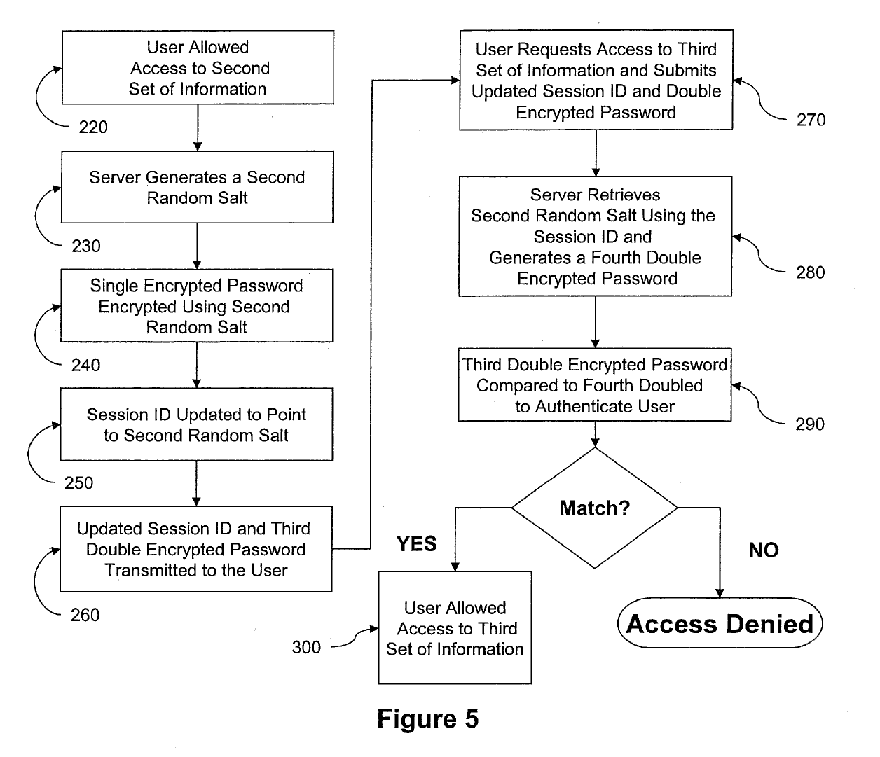

In one alternative embodiment illustrated in FIG. 5, when the user requests access to a second set of information in step 220, the server generates a second random salt in step 230. The server also retrieves the user's single encrypted password that was previously stored. The single encrypted password is then encrypted using the second random salt, thereby creating a third double encrypted password in step 240. The session ID is then updated to point to the second random salt in step 250, and the updated session ID and third double encrypted password is transmitted to the user in step 260. When the user requests access to yet another set of information by submitting the updated session ID and the third double encrypted password in step 270, the server may produce a fourth double encrypted password using the session ID to retrieve the stored second random salt in step 280. The third double encrypted password and fourth double encrypted password may then be compared to authenticate the user in step 290. The user may then be allowed access to the additional set of information in step 300.

In another alternative embodiment, the server may generate a hash produced from a user's password encrypted by a first salt and the same password encrypted by a second salt. A hash function is a cryptographic algorithm that turns an arbitrary-length input into a fixed-length binary value. This transformation is one-way, meaning that a given a hash value is statistically infeasible to re-create. In a preferred embodiment, the first salt may be a static salt and the second salt may be a random salt. The server then generates a session ID that points to the second salt. Next, the hash is transmitted to the user along with the session ID.

When the user requests access to a second set of information by submitting at least the session ID and the hash to the server, the submitted session ID is used to retrieve the random salt and the previously stored encrypted password. The server then uses the random salt and the previously stored encrypted password to produce a second hash.

This second hash may be compared to the submitted hash to authenticate the user. Additionally, the server may generate a third salt, preferably a random salt, and update the session ID to point to the third salt. The single encrypted password may then be encrypted using the third salt, which may further be used to produce a third hash. Next, the updated session ID and third hash may be transmitted to the user. When the user requests access to yet another set of information by submitting the updated session ID and the third hash, the server may produce a fourth hash by using the session ID to retrieve the stored third salt. The third hash and fourth hash may then be compared to authenticate the user.

The invention having been disclosed and illustrated by examples, various modifications and variations can be seen as possible in light of the above teachings. It should be understood that the invention is not limited to the embodiments specifically used as examples, and reference should be made to the appended claims to assess the scope of the invention in which exclusive rights are claimed.

We claim:

1. A method for managing computer security testing using data from plural sources, comprising the steps of:
(a) providing a database of computer security information, said database adapted to receive sets of data from plural computer security data sources;
(b) providing a computer-readable medium containing software for:
(1) receiving a first set of data from a first one of said plural sources, said first set of data containing information from at least one of a security task performed by said first source and a report of results from performing said security task by said first source;
(2) receiving a second set of data from a second one of said plural sources, said second set of data containing information from at least one of a security task performed by said second source and a report of results from performing said security task by said second source;
(3) preventing access, by a one of said plural sources, of data received in said security database from another of said plural sources;
(c) initiating a computer security test on a technology platform;
(d) receiving said first and second set of data;
(e) displaying information on a display device wherein said information is derived in part from at least one of said first and second sets of data; and
(f) managing the security vulnerability of the technology platform as a function of said information.

2. The method of claim 1 wherein said first source is a public data source.

3. The method of claim 2 wherein said second source is a public data source.

4. The method of claim 2 wherein said first source is the Open Source Vulnerability Database (“OSVDB”).

5. The method of claim 2 wherein said first source is selected from the group consisting of Nessus, Common Vulnerability Exposures (“CVE”), AppScan, Burp Proxy, Nmap, Nikto, WebInspect, and WebScanner.

6. The method of claim 1 wherein said database of security information includes data from the TSL Knowledgebase.

7. The method of claim 1 wherein said technology platform is selected from the group consisting of: computer, network, operating system, and software application.

8. The method of claim 1 wherein said first set of data comprises at least one of the following fields of information: a name of a security vulnerability, a description of the security vulnerability, and a recommendation for correcting the security vulnerability.

9. The method of claim 8 wherein said first set of data comprises at least one of the following fields of information: an assigned priority level for the security vulnerability and a categorization of the technology platform affected by the security vulnerability.

10. The method of claim 1 wherein said second set of data comprises at least one of the following fields of information: a name of a security vulnerability, a description of the security vulnerability, and a recommendation for correcting the security vulnerability.

11. The method of claim 10 wherein said second set of data comprises at least one of the following fields of information: an assigned priority level for the security vulnerability and a categorization of the technology platform affected by the security vulnerability.

12. The method of claim 1 including the step of updating said database of computer security information with a third set of data.

13. The method of claim 1 wherein said first set of data is obtained via a first network.

14. The method of claim 13 wherein said first network is the internet.

15. The method of claim 13 wherein said second set of data is obtained via a second network.

16. The method of claim 15 wherein said second network is the internet.

17. The method of claim 1 wherein said information includes a statistical analysis based in part on said first set of data.

18. The method of claim 1 wherein said information includes a trend analysis based in part on said first set of data.

19. The method of claim 1 wherein said information includes a comparative risk rating.

20. The method of claim 1 wherein said information includes a risk comparison chart.

21. The method of claim 1 wherein said information includes a security vulnerability frequency chart.

22. The method of claim 1 wherein said information includes a list of most common security vulnerabilities.

23. The method of claim 1 wherein said information includes a list of weighted security vulnerability impact chart.

24. The method of claim 1 wherein said first set of data is obtained by said first source after performance of an operation selected from the group consisting of:
vulnerability scan, ethical hack, and web application security test.

25. The method of claim 1 wherein said second set of data is obtained by said second source after performance of an operation selected from the group consisting of:
vulnerability scan, ethical hack, and web application security test.

26. An apparatus for managing computer security testing using data from plural sources, comprising:
a database of computer security information, said database adapted to receive sets of data from plural computer security data sources;
a processor programmed with instructions for:
(1) receiving a first set of data from a first one of said plural sources, said first set of data containing information from at least one of a security task performed by said first source and a report of results from performing said security task by said first source;
(2) receiving a second set of data from a second one of said plural sources, said second set of data containing information from at least one of a security task performed by said second source and a report of results from performing said security task by said second source;
(3) preventing access, by a one of said plural sources, of data received in said security database from another of said plural sources;
(4) initiating a computer security test on a technology platform upon receipt of a command from a user;
(5) receiving said first and second set of data;
(6) providing information that is derived in part from at least one of said first and second sets of data;
a display device for displaying said information; and
means for managing the security vulnerability of the technology platform as a function of said information.

27. The apparatus of claim 26 wherein said first source is a public data source.

28. The apparatus of claim 27 wherein said second source is a public data source.

29. The apparatus of claim 27 wherein said first source is the Open Source Vulnerability Database (“OSVDB”).

30. The apparatus of claim 27 wherein said first source is selected from the group consisting of: Nessus, Common Vulnerability Exposures (“CVE”), AppScan, Burp Proxy, Nmap, Nikto, WebInspect, and WebScanner.

31. The apparatus of claim 26 wherein said database of security information includes data from the TSL Knowledgebase.

32. The apparatus of claim 26 wherein said technology platform is selected from the group consisting of: computer, network, operating system, and software application.

33. The apparatus of claim 26 wherein said first set of data comprises at least one of the following fields of information: a name of a security vulnerability, a description of the security vulnerability, and a recommendation for correcting the security vulnerability.

34. The apparatus of claim 33 wherein said first set of data comprises at least one of the following fields of information: an assigned priority level for the security vulnerability and a categorization of the technology platform affected by the security vulnerability.

35. The apparatus of claim 26 wherein said second set of data comprises at least one of the following fields of information: a name of a security vulnerability, a description of the security vulnerability, and a recommendation for correcting the security vulnerability.

36. The apparatus of claim 35 wherein said second set of data comprises at least one of the following fields of information: an assigned priority level for the security vulnerability and a categorization of the technology platform affected by the security vulnerability.

37. The apparatus of claim 26 including means for updating said database of computer security information with a third set of data.

38. The apparatus of claim 26 wherein said first set of data is obtained via a first network.

39. The apparatus of claim 38 wherein said first network is the Internet.

40. The apparatus of claim 38 wherein said second set of data is obtained via a second network.

41. The apparatus of claim 40 wherein said second network is the internet.

42. The apparatus of claim 26 wherein said information includes a statistical analysis based in part on said first set of data.

43. The apparatus of claim 26 wherein said information includes a trend analysis based in part on said first set of data.

44. The apparatus of claim 26 wherein said information includes a comparative risk rating.

45. The apparatus of claim 26 wherein said information includes a risk comparison chart.

46. The apparatus of claim 26 wherein said information includes a security vulnerability frequency chart.

47. The apparatus of claim 26 wherein said information includes a list of most common security vulnerabilities.

48. The apparatus of claim 26 wherein said information includes a list of weighted security vulnerability impact chart.

49. The apparatus of claim 26 wherein said first set of data is obtained by said first source after performance of an operation selected from the group consisting of: vulnerability scan, ethical hack, web application security test, and system security configuration assessment.

50. The apparatus of claim 26 wherein said second set of data is obtained by said second source after performance of an operation selected from the group consisting of: vulnerability scan, ethical hack, and web application security test.
